(19) United States
(12) Patent Application Publication
(10) Pub. No.: US 2008/0130876 A1
(43) Pub. Date: Jun. 5, 2008

(54) Method for Private-Key Encryption of Messages, and Application to an Installation

(75) Inventors: Patricia Etienne, Le Pouliguen (FR); Roger Suanez, Le Pouliguen (FR)

Correspondence Address: YOUNG & THOMPSON, 209 Madison Street, Suite 500, ALEXANDRIA, VA, 22314, US

(73) Assignee: ALGORIL HOLDING, ZOUG (CH)

(21) Appl. No.: 11/795,691

(22) PCT Filed: Feb. 9, 2006
(86) PCT No.: PCT/FR06/00298

§ 371 Date: Jul. 20, 2007

(30) Foreign Application Priority Data
Feb. 9, 2005 (FR) 05 01310

(51) Int. Cl. H04L 9/06

(52) U.S. Cl. 380/29

(57) ABSTRACT

The invention concerns a multiple private key and secondary key cryptography method, including segmentation into blocks having a specific number of characters, and, for each block, a first step of encrypting each block with a first part of the multiple private key, determining an intermediate key specific to the block from the multiple private key and the secondary key, processing each block with at least one algorithm dependent on the intermediate key, said processing providing a processed block, and a second step of encrypting the processed block, and, for the set of blocks, forming a cryptogram including the processed blocks and characters representing the secondary key.

The present invention relates to a cryptographic system, or cryptosystem, which can be used in a wide range of applications and in various forms, and it relates more specifically to a message encryption method and to applications of this method.

Cryptographic systems are used in applications which relate substantially to two major fields: on the one hand checks on civil status and filiation, authenticity, integrity and non-repudiation, and on the other hand checks on confidentiality, authenticity and traceability of sources.

Examples in the first field of applications include messaging, identity documents and statutory documents.

Examples in the second field of applications include checking for falsification of values and counterfeiting of objects.

The conditions of use vary according to the applications. Thus, some applications require a particularly high level of security, in particular regarding confidentiality, integrity of information, authentication or identification of an entity, signature, validation, access control, certification, etc., while in other applications performance levels or ease of implementation are more important.

The invention relates to a cryptographic system enabling these various outcomes to be achieved, by implementing various cryptographic methods. It is therefore necessary to examine the various aspects implemented in the cryptographic system according to the invention.

The main categories of cryptographic systems are, on the one hand, private-key (symmetric) systems and, on the other hand, public-key (asymmetric) systems.

Private-key cryptographic systems, in which the keys are intended to be kept secret, implement either a block cipher, or a stream cipher. The invention implements block ciphers. In this type of encryption, the plaintext message is separated into blocks of fixed length, and an algorithm encrypts one block at a time. Security is increased when the blocks are longer, but then the processing time increases notably.

The block cipher employs modes of operation and transformations.

The modes of operation are block cipher methods, some of which have been standardised. They comprise mainly the four modes of operation—ECB (Electronic Codebook), CBC (Cipher Block Chaining), CFB (Cipher Feedback) and OFB (Output Feedback)—which are increasingly complex and cumbersome to implement.

The simplest mode of operation is the ECB (Electronic Codebook) mode which involves applying an algorithm to the plaintext message block. This mode of operation has two drawbacks: the first is that, if the message contains two identical parts of plaintext, the cryptogram obtained will produce identical result parts. The second drawback is that a certain number of characters of the plaintext message is needed before the encryption can start. In most of the fields that the invention is concerned with, only the first problem is truly significant.

The transformations, used in the block cipher, include the substitution cipher, the transposition cipher and the product cipher which is a combination of the previous two transformations.

The other category of cryptographic systems is based on a public key. In such systems, a plaintext message is transformed into a cryptogram using a public key, and the cryptogram is transformed into a plaintext message using the private key of the recipient.

For example, the document EP-792 041 describes a cryptographic system, preferably a public-key system, in which complex masking operations are executed on blocks obtained after initial addition of supplementary data.

These public-key systems have the drawback of requiring many operations, and they are not therefore not recommended when large amounts of information need to be transmitted.

These systems implement a number of technologies intended to authenticate the recipients. Thus digital signature techniques, factorisation techniques and discrete logarithms are used in particular.

The invention relates to a cryptographic system in which operations are implemented that are simple to execute, but which belong to different types, such that performance levels can be very high with nevertheless high levels of security. In particular, the key needed for decryption hanges at each block, and therefore, in the unlikely event that the key of a block is broken, that key cannot be reused for another block.

The invention combines in essence substitution cipher operations and simple modes of operation, with algorithmic processing. Security is increased by virtue of the use of a secondary key in addition to a private multiple key. This secondary key for each block can be from various sources, for example a random key and/or one drawn from a public key.

More specifically, the invention relates to a method for encrypting plaintext messages formed of characters drawn from an alphabet, using a private multiple key and a secondary key; it involves the division into blocks having a determined number of characters, and, for each block,
a first step for encrypting each block with a first part of the private multiple key,
the determination of an intermediate key specific to the block from the private multiple key and from the secondary key,
the processing of each block by at least one algorithm which depends on the intermediate key, this processing resulting in a processed block, and
a second step for encrypting the processed block, then, for all the blocks, the formation of a cryptogram containing the processed blocks and characters representing the secondary key.

In one advantageous implementation, the first step for encrypting each block involves a first phase executing a substitution cipher using a first part of the private multiple key, and a second phase of encryption by a first algorithm.

Likewise, it is advantageous for the second step for encrypting each block to involve a third phase of encryption by a first algorithm, and a fourth phase executing a substitution cipher using the first part of the private multiple key.

In one implementation, the secondary key is constructed from a public key, and the determination of the intermediate key involves using the public key, the private multiple key and at least one character of the block, in order that the intermediate key is specific to the block.

In another implementation, the secondary key includes at least one random number, for example two random numbers.

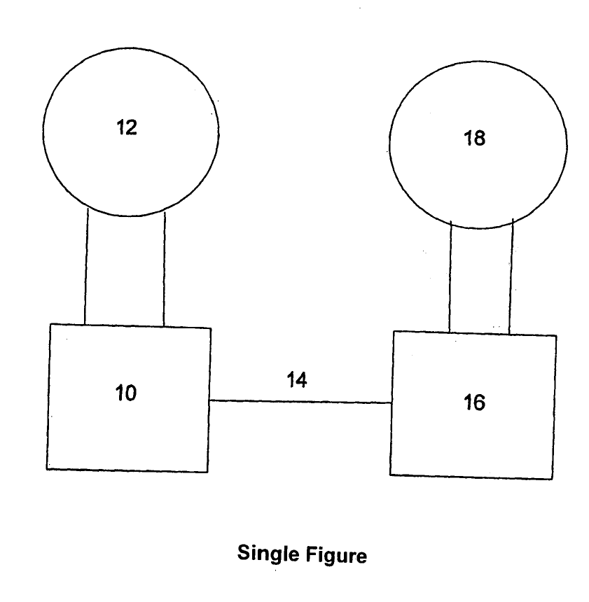

In another implementation, the secondary key can be obtained from any other known cryptographic system, for example as described with reference to FIG. 3 in the document WO 2004/006498.

It is advantageous for the processing to include, in addition, the insertion of at least one character representing the secondary key. For example, the formation of the cryptogram involves the insertion of at least one character representing the secondary key in the block in at least one position defined using the secondary key. In addition or alternatively, the formation of the cryptogram involves the insertion of at least one character representing the secondary key in the block in at least one position defined in a recurrent manner from one block to the next.

In one implementation, the formation of the cryptogram involves arranging the cryptogram in two parts, one that can be read by a first reading means and the other by a second reading means. For example, the first reading means operates in the visible spectrum, and the second reading means operates outside the visible spectrum or is a magnetic reading means.

It is advantageous for the step for dividing into blocks to involve the addition of random characters in order that all blocks containing meaningful characters are of the same length.

Preferably, the method also includes the addition of a truncated block at the end of the cryptogram, in order that the latter is not always a multiple of the block length.

Preferably, the method also includes the addition of a consistency code to the cryptogram, allowing a check to be made as to whether the cryptogram is genuine.

In one application, the method involves applying the cryptogram on a product. For example, the step for applying the cryptogram on a product implements a technique such as printing directly onto the product, printing a label intended to be fixed to the product, permanently marking the product, engraving the product, or providing a seal associated with an opening in a container of the product.

The invention relates also to applying the method according to the preceding paragraphs to an installation which includes an interrogation system and at least one authentication system, the method involving a step for transmitting the cryptogram from the interrogation system to the authentication system by a means which is unprotected, i.e. possibly accessible to third parties.

In that case, it is advantageous for the method to involve, after the step for transmitting the cryptogram from the interrogation system to the authentication system, comparing a part at least of the plaintext message obtained from the cryptogram with data in a database of the authentication system, and, depending on the result of the comparison, sending, by the authentication system to the interrogation system, an authentication message or a non-authentication message.

Preferably, the method also involves storing, in the database of the authentication system, additional information containing at least one date, the additional information constituting traceability data intended to be transmitted, at least partly, to the interrogation system.

Preferably, the method involves storing data in at least two databases of two separate authentication systems, the two databases having, on the one hand, common data and, on the other hand, specific data.

Preferably, the specific data in the database of a first authentication system contains traceability data, and the specific data in the database of a second authentication system contains additional data relating to the products.

Other features and advantages of the invention will be better understood on reading the following description of an example implementation given with reference to the appended drawing in which the single FIGURE is a block diagram of an installation implementing the method according to the invention.

The single FIGURE schematically represents an installation which transmits cryptograms according to a method according to the invention. In the drawing, the reference 10 denotes a transmitter of an interrogation system, connected for example to a protected private network 12. A cryptogram transmitted by the transmitter 10 over an unprotected network 14, for example a telephone network or the Internet, reaches a receiver 16 of an authentication system, which can form part of another protected private network 18.

The system is vulnerable only by the network between the transmitter and the receiver. A third party can in fact obtain the cryptogram and subject it to all forms of attack. However, given the diversity of the technologies implemented, a considerable length of time is already needed to “break” only one block. The result obtained cannot be reused for the subsequent blocks, and therefore decrypting without knowing the private multiple key is in practice impossible.

An example implementation of the invention will now be described.

Suppose an initial plaintext message contains 67 characters. It is divided into blocks, for example of seven characters. The three missing characters to obtain ten complete blocks are added in the form of padding characters to the end of the message.

Next, each block is subjected to a substitution cipher using a first part of the private multiple key, this first part being in the form of an alphabet, for example with 45, 60 or 67 characters. The result can be presented in alphanumeric or numeric form, for example in the form of successive numbers, for example two-digit numbers.

The message then undergoes an encryption by an algorithm executed separately on each block. This algorithm can be for example of the “factorial” type; in that case, it is desirable that the number of characters in each block is not too high, since the computation time could increase excessively.

Before, during or after these operations, a secondary key is obtained. Although this secondary key can be constructed from a public key, in one advantageous implementation of the invention, this secondary key is in the form of a pair of random numbers, for example two-digit numbers. Algorithmic processing of these numbers results in for example, on the one hand a function used as an algorithm forming an intermediate key, and on the other hand two positions in a block of nine characters (seven characters in each block, plus two characters corresponding to the two random numbers).

The intermediate key thus obtained is used to encrypt the message obtained during the previous operation.

Then, the block is encrypted using another algorithm, corresponding to the one which has already been used, and then it is encrypted by substitution.

Next, the two random numbers for each block, corresponding to two characters, are inserted in this block in the previously defined positions. The blocks are then chained to form an encrypted message or cryptogram. A truncated block, the purpose of which is to prevent all the cryptograms having the same number of characters or to prevent this number being a multiple of that of the blocks, is added if necessary.

Preferably, the positions defined from the random numbers are not simply defined by the two numbers, but are obtained in a recurrent manner, by using positions in the previous block for example. As this processing relates only to two two-digit-only numbers, it is fast and does not excessively increase the time for the whole encryption.

It is possible to add to the cryptogram a consistency code, similar to that used to check the consistency of bank card numbers. However, this code is not simply numeric, since it comprises preferably one or two characters chosen from all the characters of the alphanumeric base used for the cryptogram. Thus, without any connection to a certification system, it is possible to determine whether the cryptogram is genuine, i.e. if it is consistent with the rules applied for constructing the cryptogram.

When the cryptogram is to be decrypted, the first operation is the determination of the random numbers. These two numbers, or one at least, can have either a defined position in a block, such as the first, the last or a determined block, or a determined position based on the block itself. Once the first number and the recurrence law are known, the set of random numbers for all the blocks can be reconstructed. At this moment, the characters in the cryptogram corresponding to these numbers are removed, and the seven-character blocks are re-established. The decryption operations can then be executed, using the private multiple key, in reverse order of the operations used for the encryption.

The formation of a cryptogram has been described by considering simply a plaintext message independently of its meaning, and of its structure.

In one example plaintext message, used to determine the authenticity of objects produced, the message can include, with a defined format, a product serial number, a brand identifier, a date of manufacture, codes defining a factory, a production line, a product, and if necessary the source of hazardous components. The message can also contain geographical co-ordinates of the destination area, a country, an administrative region, etc. Such information provides for backward traceability and forward traceability.

After decryption, and by comparing with data in a database, it is possible to determine, based on the serial number, whether the article is counterfeit, based on the brand identifier, whether the source is suspect, based on the area coordinates, whether the delivery is suspect, etc.

It has been mentioned that the message was transmitted over a network. However, in the case of products, the message can be borne by the products themselves. It is possible for the product to bear the entire message. Such a message can then if necessary be reproduced by photocopy. The photocopy can be determined either by technical means (reduction of definition), or by comparing with a database.

However, it is possible provide additional protection here. Specifically, it is possible to divide the cryptogram into at least two parts which are not visible simultaneously. For example, a first part is visible under natural light, and a second part is visible only under infrared light or by magnetic reading. Such features increase the complexity of unauthorised decryption to such an extent that the security is almost absolute.

Thus, the invention provides for implementing a cryptographic system in which the protection of messages is extremely high. However, there are also a number of applications in which security, although essential, has a lesser significance due to, for example, the low cost of the products to which the cryptograms are affixed. It is then possible to use simplified processing. For example, a single random number can have a position that is always identical in the blocks, and it can be used for selecting a particular alphabet from a series of alphabets contained in the multiple private key.

By combining several simple encryption methods, the drawbacks of each of them are eliminated by the presence of the others. Thus, the main drawback of the block cipher, which is that the same plaintext always produces the same result after encryption, is eliminated by virtue of the secondary key which is different at each block. The same plaintext message does not produce the same result twice.

Depending on the security requirements, the method can be a two-level method: first, a method as described is executed by the transmitter, then the transmitter transmits the cryptogram transformed by the public-key system, and the recipient decrypts the received message using his private key corresponding to the public key, then decrypts the cryptogram according to the method described in the present specification.

Of course, the various features described above can be combined in various ways without departing from the scope of the invention.

The main advantages of the cryptographic system described are:
its lightness, due to the simplicity in the processing involved and the absence (optional) of a public key,
its security, owing to the diversity of the processing techniques executed sequentially and without correlation,
its scope in adapting the security level to the particular application,
its flexibility in adapting to existing situations in the particular application, and
its low cost achieved by virtue of high processing speeds and simplicity of implementation.

The invention, by virtue of these advantages, is suitable for a very large number of applications.

A first group of applications concerns the securing of identity documents (for example, identity cards), statutory documents (for example, vehicle cards) and the economy (for example, work permits).

A second group of applications concerns the securing of payment means (for example, bank cards) and tickets (for example, event tickets).

A third group of applications concerns the legalisation of information exchanged by messaging or borne by electronic chips (for example, signatory certification confirmation).

A fourth group of applications concerns encoding and encryption without public key (for example, the securing of data transfers in information networks).

A fifth group of applications concerns the authentication of goods and objects (for example, fraud and counterfeiting in the fields of luxury goods, music, etc.).

By way of example, the application of the invention to authenticating goods consisting of bottles of appellation wine will now be considered.

A producer of appellation wines orders, from a certifying body, a quantity of labels corresponding to the number of bottles to be sold. The latter prints the required number of labels with a specific cryptogram for each label. It preserves in a database information concerning the identification of the producer, such as name, country and postal code, the identification of the wine, such as its appellation, its vineyard and its vintage, and the serial number of the bottle, preferably including a batch number. In the example in question, the information identifying the producer, such as name, country and postal code, and that identifying the wine, such as its appellation, its vineyard, its vintage and its batch number form “common” items of information, and the serial number of the bottle, at least, forms “specific” information.

When the producer has affixed the labels and dispatched the batch of bottles in question to a first recipient, he notifies either the certifying body which has supplied him the labels, or a central certifying body which is then brought into communication with the first certifying body. In this way, the first certifying body supplies the “common” information to the central certifying body. The latter adds to its own database information that is specific to it, such as the delivery date and the identity of the first recipient.

When the first recipient performs a transaction on the batch of bottles, he notifies the central certifying body which stores in its database new specific data, such as the date of the new transaction and the identity of the second recipient. The process can be continued at each new transaction, such that the central certifying body ensures that the bottles are traceable.

The certifying bodies are “authentication systems” which can be queried by any “interrogation system”. An interrogation system can be a computer connected to a computer network, or even a simple mobile telephone connected to a telephone network capable of placing it in communication with a certifying body. For this reason, given the small number of characters that can easily be read on a mobile telephone, it is advantageous for the number of alphanumeric characters used for the cryptogram to be limited, for example to thirty-four.

When the source of a bottle is to be checked, for example by a border control authority or by an ordinary potential buyer, three certifications are possible. The first certification is the determination of consistency, without connecting to any certifying body. The second and third certifications are obtained either by connecting to the central certifying body which not only authenticates the bottle by transmitting a plaintext message but can also transmit traceability data such as the place where the bottle should be located, or by connecting to the first certifying body which not only authenticates the bottle but can also transmit additional information such as the bottle number, information on the particular wine, etc.

This is a simple example application to a particular product. Depending on the nature of the product, special arrangements providing various security levels can be made. For example, instead of printing a label stuck to the product after printing, it is possible to print, permanently mark or engrave the cryptogram directly on the product. It is also possible to provide a seal at the opening of a container of the product, for example a perfume bottle, or on its packaging.

1. A method for encrypting plaintext messages formed of characters drawn from an alphabet, using a private multiple key and a secondary key, characterised in that it involves:
division into blocks having a determined number of characters, and,
for each block,
a first step for encrypting each block with a first part of the private multiple key,
the determination of an intermediate key specific to the block from the private multiple key and from the secondary key,
the processing of each block by at least one algorithm which depends on the intermediate key, this processing resulting in a processed block, and
a second step for encrypting the processed block, and,
for all the blocks,
the formation of a cryptogram containing the processed blocks and characters representing the secondary key.

2. A method according to claim 1, characterised in that the first step for encrypting each block involves a first phase executing a substitution cipher using a first part of the private multiple key, and a second phase of encryption by a first algorithm.

3. A method according to claim 1, characterised in that the second step for encrypting each block involves a third phase of encryption by a first algorithm, and a fourth phase executing a substitution cipher using the first part of the private multiple key.

4. A method according to claim 1, characterised in that the secondary key includes at least one random number.

5. A method according to claim 1, characterised in that the formation of the cryptogram involves the insertion of at least one character representing the secondary key in the block in at least one position defined using the secondary key.

6. A method according to claim 1, characterised in that the formation of the cryptogram involves the insertion of at least one character representing the secondary key in the block in at least one position defined in a recurrent manner from one block to the next.

7. A method according to claim 1, characterised in that the formation of the cryptogram involves arranging the cryptogram in two parts, one that can be read by a first reading means and the other by a second reading means.

8. A method according to claim 1, characterised in that the step for dividing into blocks involves the addition of random characters in order that all blocks containing meaningful characters are of the same length.

9. A method according to claim 1, characterised in that the method also includes the addition of a truncated block to the cryptogram.

10. A method according to claim 1, characterised in that the method also includes the addition of a consistency code to the cryptogram.

11. A method according to claim 1, characterised in that it involves applying the cryptogram on a product.

12. A method according to claim 11, characterised in that the step for applying the cryptogram on a product implements a technique chosen from printing on the product, printing a label intended to be fixed to the product, permanently marking the product, engraving the product, and providing a seal associated with an opening in a container of the product.

13. An application of the method according to claim 1 to an installation which includes an interrogation system and at least one authentication system, characterised in that the method involves transmitting the cryptogram from the interrogation system to the authentication system by a means which is unprotected.

14. An application according to claim 13, characterised in that the method involves, after the cryptogram is transmitted from the interrogation system to the authentication system, comparing a part at least of the plaintext message obtained from the cryptogram with data in a database of the authentication system, and, depending on the result of the comparison, sending, by the authentication system to the interrogation system, an authentication message or a non-authentication message.

15. An application according to claim 14, characterised in that the method also involves storing, in the database of the authentication system, additional information containing at least one date, the additional information constituting traceability data intended to be transmitted, at least partly, to the interrogation system.

16. An application according to claim 14, characterised in that the method involves storing data in at least two databases of two separate authentication systems, the two databases having, on the one hand, common data and, on the other hand, specific data.

17. An application according to claim 16, characterised in that the specific data in the database of a first authentication system contains traceability data.

18. An application according to claim 16, characterised in that the specific data in the database of a second authentication system contains additional data relating to the products.

19. A method according to claim 2, characterised in that the second step for encrypting each block involves a third phase of encryption by a first algorithm, and a fourth phase executing a substitution cipher using the first part of the private multiple key.
